(19) United States
(12) Patent Application Publication
(10) Pub. No.: US 2012/0006256 A1
(43) Pub. Date: Jan. 12, 2012

(54) APPARATUS FOR MANUFACTURING CERAMIC GREEN SHEET

(75) Inventors: Won Seop Choi, Gyeonggi-do (KR); Dae Bok O, Seoul (KR)

(73) Assignee: SAMSUNG ELECTRO-MECHANICS CO., LTD.

(21) Appl. No.: 12/945,490

(22) Filed: Nov. 12, 2010

(30) Foreign Application Priority Data
Jul. 8, 2010 (KR) 10-2010-0065856

(51) Int. Cl. B05C 9/12; B05C 11/00

(52) U.S. Cl. 118/50; 118/58; 118/61

(57) ABSTRACT

Disclosed herein is an apparatus for manufacturing a ceramic green sheet, including: an applying unit that applies slurry to a film; a drying unit that dries the slurry applied to the film and forms the ceramic green sheet; and a pollution preventing unit having the drying unit therein to prevent pollution materials from moving between the drying unit and the outside environment.

### CROSS REFERENCE(S) TO RELATED APPLICATIONS

This application claims the benefit under 35 U.S.C. Section [120, 119, 119(e)] of Korean Patent Application Serial No. 10-2010-0065856, entitled Apparatus For Manufacturing Ceramic Green Sheet, filed on Jul. 8, 2010, which is hereby incorporated by reference in its entirety into this application.”

### BACKGROUND OF THE INVENTION

1. Technical Field

The present invention relates to an apparatus for manufacturing a ceramic green sheet, and more particularly, to an apparatus for manufacturing a ceramic green sheet including a pollution preventing unit in which a drying unit drying slurry is received.

2. Description of the Related Art

In order to develop an ultra-high capacity laminated ceramic condenser, a ceramic green sheet should be thinned and multi-layered. However, the reduction in the thickness of the ceramic green sheet and the increase in the number of stacking cause the increase of electrical shorts between chips. The reason is that the electrical short is easily generated even when at the slightest defect as the ceramic green sheet becomes thin.

Therefore, in order to manufacture the ultra-high capacity laminated ceramic condenser, it may be essential to manufacture the ceramic green sheet having the defect-free thin film.

Meanwhile, an apparatus for manufacturing the ceramic green sheet may include an applying unit that applies slurry including a ceramic powder, a binder resin, and a solvent on a film and a drying unit that dries the applied slurry.

The drying unit includes an inlet and an outlet that inputs and discharges the slurry to and from the applied film, wherein the inlet and the outlet are opened. Therefore, the pressure difference may be generated inside and outside the drying unit. In particular, when the drying unit moves the film by a roll-to-roll manner, the inlet and outlet of the drying unit are directly connected to the outside, such that the pressure difference between the inside and the outside of the drying unit may largely be generated.

In addition, the drying unit controls the pressure therein to be higher and lower than that of the outside thereof according to the thickness of the slurry to be dried, thereby making it possible to manufacture the defect-free ceramic green sheet. In other words, in order for the drying unit to control the drying of the slurry, the pressure difference may occur inside and outside the drying unit.

Due to the pressure difference in the inside and outside of the drying unit, the inside of the drying unit may be polluted by the introduction of the outside air into the drying unit or the working environment may be polluted by the discharge of the organic solvent remaining in the drying unit to the outside rather than to the outlet.

### SUMMARY OF THE INVENTION

An object of the present invention is to provide an apparatus for manufacturing a ceramic green sheet capable of reducing pollution inside and outside a drying unit by including a pollution preventing unit in which the drying unit drying slurry is received.

According to an aspect of the present invention, there is provided an apparatus for manufacturing a ceramic green sheet, including: an applying unit that applies a slurry to a film; a drying unit that dries the slurry applied to the film and forms the ceramic green sheet; and a pollution preventing unit having the drying unit therein to prevent pollution materials from moving between the drying unit and the outside environment.

The inside of the pollution preventing unit may maintain a negative pressure.

When the thickness of the ceramic green sheet is in a thickness range below 0.01 to 2 μm, the inside of the drying unit may maintain a positive pressure.

When the thickness of the ceramic green sheet is in a thickness range of 2 to 100 μm, the inside of the drying unit may maintain a negative pressure.

The drying unit may include an exhaust unit and a suction unit disposed along a moving direction of the film.

The apparatus for manufacturing a ceramic green sheet may further include a filter unit included in the exhaust unit.

The drying unit may include an inlet disposed on one side of the drying unit to input the film including the slurry and an outlet disposed on the other side of the drying unit to discharge the film including the green sheet.

The pollution preventing unit includes an additional inlet disposed before the inlet and an additional outlet disposed after the outlet.

The pollution preventing unit may include an additional exhaust unit.

The apparatus for manufacturing a ceramic green sheet may further include an additional filter unit included in the additional exhaust unit.

### BRIEF DESCRIPTION OF THE DRAWINGS

FIG. 1 is a diagram schematically showing a part of a device for manufacturing a ceramic green sheet according to an exemplary embodiment of the present invention.

### DESCRIPTION OF THE PREFERRED EMBODIMENTS

Hereinafter, exemplary embodiments of the present invention will be described in detail with reference to the drawings of an apparatus for manufacturing a ceramic green sheet. The exemplary embodiments of the present invention to be described below are provided by way of example so that the idea of the present invention can be sufficiently transferred to those skilled in the art to which the present invention pertains. Therefore, the present invention may be modified in many different forms and it should not be limited to the embodiments set forth herein. In the drawings, the size, and the thickness of the device may be exaggerated for convenience. Like reference numerals denote like elements throughout the specification.

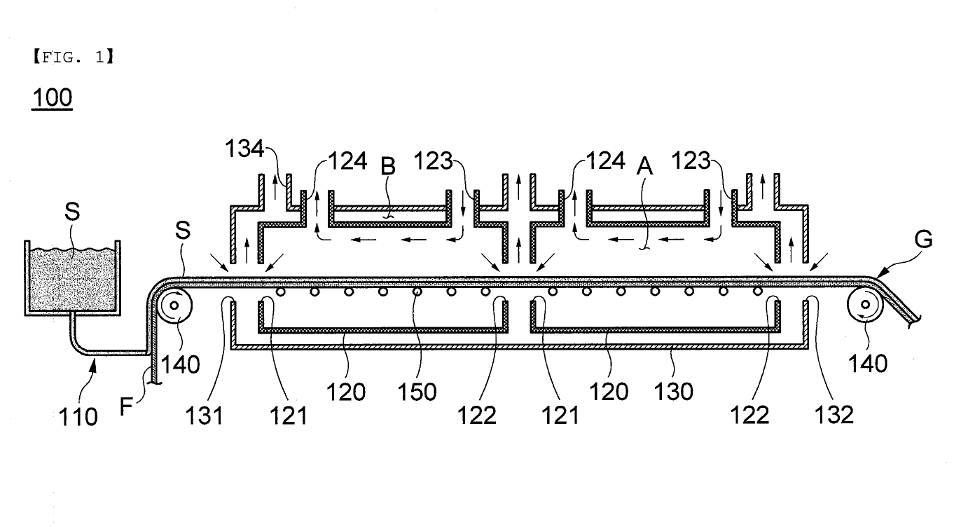

FIG. 1 is a diagram schematically showing a part of a device for manufacturing a ceramic green sheet according to an exemplary embodiment of the present invention.

Referring to FIG. 1, an apparatus 100 for manufacturing a ceramic green sheet according to an exemplary embodiment of the present invention may include an applying unit 110, a drying unit 120, and a pollution preventing unit 130 in which the applying unit 110 and the drying unit 120 are received.

The applying unit 110 may serve to apply a slurry S including a ceramic powder, a binder resin, and a solvent on a film F. In this case, the ceramic powder, the binder resin, and the solvent may generally be used without limit if they are a material capable of forming the green sheet. In addition, an example of a material forming the film F may include PET but the exemplary embodiment of present invention is not limited thereto.

The applying unit 110 may apply the slurry S to the film F by a spraying manner. However, the exemplary embodiment of the present invention is not limited thereto. For example, the applying unit 110 may be a doctor blade device, a roll coating device, a reverse coating device, a slit die coating device, or the like.

The applying of the slurry S may be performed on the film F moving in a vertical direction to the ground. In this case, the slurry S may be easily formed to have a thin film, for example, a thickness range of 0.01 to 2 μm on the film F. However, the exemplary embodiment of the present invention is not limited thereto and when the slurry S is formed on the film F to have, for example, a thickness range of 2 to 100 μm, the applying of the slurry S may be performed on the film F moving in a horizontal direction to the ground.

When the applying of the slurry S is performed on the film moving in the vertical direction to the ground, the film F to which the slurry S is applied may move to the drying unit 120 from a vertical or tilt state to a horizontal state by a vacuum roll 140. In this case, the vacuum roll 140 may include a plurality of vacuum holes. In this case, after vacuuming is applied through the vacuum hole, the film F applied with the slurry S may move by the rotation of the vacuum roll 140.

In addition, although not shown in FIG. 1, tension rollers that are rotated by being interlocked to each other before an additional inlet of a pollution preventing unit, to be described below, and after an additional outlet thereof may be further provided in order to maintain the tension of the film. Therefore, the film may be horizontally maintained during the drying process, thereby making it possible to prevent the thickness of the slurry S applied to the film from being non-uniform due to the deformation of the film.

The drying unit 120 may serve to dry the slurry S applied to the film F to form a ceramic green sheet G. In this case, the drying unit 120 may include a heating unit for drying the slurry.

The drying unit 120 may include an inlet 121 disposed on one side of the drying unit for inputting the film F including the slurry S and an outlet 122 disposed on the other side thereof to discharge the dried slurry S, that is, the film F including the green sheet G.

The drying unit 120 may include an exhaust unit 124 and a suction unit 123 that are sequentially disposed according to a sequence of the moving direction of the film F. In other words, the exhaust unit 124 is disposed to be close to the inlet 121 and the suction unit 123 may be disposed to be close to the outlet 122. Therefore, an air flow may generate in a direction opposite to the moving direction of the film in the drying unit 120 and the concentration of the solvent in the drying unit 120 may be uniform for each region. This may cause a defect of the ceramic green sheet since the concentration of the solvent volatilized from the slurry S may be set to be higher in the inlet 121 of the drying unit 120 than in the outlet 122 thereof.

Further, although not shown in FIG. 1, the drying unit 120 may further include a valve that can control the opening and closing of the exhaust unit 124 and the suction unit 123.

The pressure in the drying unit 120 may be controlled in consideration of the thickness of the ceramic green sheet to be formed. The pressure in the drying unit 120 may be controlled by opening and closing the exhaust unit 124 and the suction unit 123. In addition, although not shown in FIG. 1, the exhaust unit 124 includes a filtering unit to remove the pollution materials from the polluted air.

In detail, when the ceramic green sheet G having a thin film, that is, a thickness range of 0.01 to 2 μm is manufactured, the amount of solvent contained in the slurry applied on the film F is small, such that the slurry may be abruptly dried at the early stage of drying. As a result, defects may occur in the ceramic green sheet G. The defect free thin film ceramic green sheet G may be manufactured by reducing the drying rate of the slurry. In this case, in order to reduce the drying rate of the slurry, the amount of air discharged to the outside of the drying unit 120 through the exhaust unit 124 should be reduced more than that of air sucked into the drying unit 120 through the suction unit 123 of the drying unit 120. In this case, a positive pressure is generated in the drying unit 120, such that the organic solvent volatilized at the time of drying the slurry in the drying unit 120 is discharged through the inlet or the outlet of the drying unit 120 rather than the exhaust unit, thereby polluting the working environment.

On the other hand, when the ceramic green sheet having a thick film, that is, a thickness range of 2 to 100 μm is manufactured, the amount of slurry applied to the film F is increased and thus, the amount of solvent contained in the slurry S applied to the film F is increased. As a result, it is preferable to increase the drying rate of the slurry S in order to completely dry the slurry S.

In order to increase the drying rate of the slurry S, the amount of air discharged to the outside of the drying unit 120 through the exhaust unit 124 of the drying unit 120 should be increased more than that of air sucked into the drying unit 120 through the suction unit 123 of the drying unit 120. In this case, a negative pressure is generated in the drying unit 120, such that the polluted air is input into the drying unit 120 through the suction unit 123 as well as the inlet 121 or the outlet 122 of the drying unit 120 without the filter, thereby polluting the inside of the drying unit 120.

In order to manufacture the ceramic green sheet defect or non-drying, it is determined by controlling the pressure in the drying unit 120 and the corresponding drying rate of the slurry; but, it causes a problem in that the polluted air moves to the inside or outside of the drying unit 120.

In order to improve this problem, the apparatus 100 for manufacturing the ceramic green sheet may include a pollution preventing unit 130 having the drying unit 120 therein to prevent the polluted air from moving to the inside of the drying unit 120 or the outside environment of the drying unit 120, for example, the working environment or a clean room. In this configuration, the pollution preventing unit 130 may include an additional exhaust unit 134 that discharges the polluted air.

The polluted air may be discharged from the inside or outside environment of the drying unit 120 through an additional exhaust unit 134 of the pollution preventing unit 130 by controlling the inside pressure of the pollution prevention unit 130. For example, in order to manufacture the thin film ceramic green sheet, when the positive pressure is generated in the drying unit 120, the inside of the pollution preventing unit 130 maintains a negative pressure. That is, the inside of the pollution preventing unit 130 is maintained at a smaller pressure than that of the inside of the drying unit 120 and the working environment. Therefore, the polluted air discharged from the inside of the drying unit 120 may be discharged through the additional exhaust unit 134 through the inside of the pollution preventing unit 130. That is, the pollution preventing unit 130 may serve to prevent the polluted air of the drying unit 120 from being discharged to the outside environment. On the other hand, in order to manufacture the thick film ceramic green sheet, when a negative pressure is generated in the drying unit 120, the polluted air of the outside environment is not input into the drying unit 120 but may be discharged through the additional exhaust unit 134 by maintaining the inside of the pollution preventing unit 130 less pressure than that of the inside of the drying unit 120.

The pollution preventing unit includes an additional inlet 131 disposed before the inlet 121 of the drying unit 120 and an additional outlet 132 disposed after the outlet 122 of the drying unit 120, thereby making it possible to input and discharge the film F applied with the slurry S.

In addition, a plurality of conveyor rollers 150 disposed to penetrate through the drying unit 120 may be further provided. The film F applied with the slurry S may be easily moved through the conveyor roller 150 during the drying process.

In addition, although not shown in FIG. 1, the additional exhaust unit 134 is provided with the additional filter unit to remove the pollution materials from the polluted air discharged by the pollution preventing unit 130.

Therefore, the pollution preventing unit can prevent the polluted air from being input into the drying unit 120 or the working environment, regardless of the pressure in the drying unit 120. In addition, the present invention can control the pressure in the drying unit 120 without considering the pollution of the drying unit 120 or the working environment, thereby making it possible to manufacture a defect free thin film ceramic green sheet or the completely dried thick film ceramic green sheet while preventing pollution of the working environment.

The exemplary embodiment of the present invention describes that the apparatus 100 for manufacturing the ceramic green sheet includes two drying units but is not limited thereto. Therefore, the exemplary embodiment of the present invention may include one drying unit or two or more drying units.

Hereinafter, Table 1 shows the results of comparing the degree of pollution of the drying unit and the outside environment according to whether the apparatus for manufacturing the ceramic green sheet includes the pollution preventing unit.

TABLE 1

| | Number of polluted | | Exposed level to organic | |
|---|---|---|---|---|
| | particles of drying | | solvent of outside | |
| Relative | unit | | environment (ppm) | |
| pressure of | Comparative | | Comparative | |
| drying unit | Example | Example | Example | Example |
| Positive | 11~18 | 11~18 | 50~100 | 10 or less |
| pressure | | | | |
| Negative | 35~53 | 13~24 | 10 or less | 10 or less |
| pressure | | | | |

In Table 1, the Comparative Example measured the degree of pollution by using the apparatus for manufacturing the ceramic green sheet without the pollution preventing unit and the Example measured the degree of pollution by using the apparatus for manufacturing the ceramic green sheet with the pollution preventing unit. The degree of pollution in the drying unit was confirmed as the number of polluted particles having a size of 0.5 μm or so. In addition, the degree of pollution of the outside environment was confirmed as the concentration of toluene.

As in Table 1, when the pressure in the drying unit is a positive pressure, the degree of pollution in the drying unit is similar to each other but when the pressure in the drying unit is a negative pressure, the degree of pollution of the apparatus for manufacturing the ceramic green sheet according to the Example is smaller than that of the Comparative Example. It can be confirmed that when the pressure in the drying unit is a negative pressure, the polluted particles may be input into the drying unit from the outside but as in the Example, when it includes the pollution preventing unit, the input of the polluted particles into the drying unit is prevented.

In addition, it can be confirmed that when the pressure in the drying unit is a negative pressure, the degree of pollution of the outside environment is similar to each other, but when the pressure in the drying unit is a positive pressure, the degree of pollution of the outside environment is reduced when using the apparatus for manufacturing the ceramic green sheet according to the Example rather than the Comparative Example. It can be confirmed that when the pressure in the drying unit is a positive pressure, the toluene discharged from the drying unit may be discharged to the outside environment, but as in the exemplary embodiment, when it includes the pollution preventing unit, the discharge of the toluene to the outside environment is prevented.

Therefore, as in the example of the present invention, it can be confirmed that when the apparatus for manufacturing the ceramic green sheet includes the pollution preventing unit, the degree of pollution of the inside or outside environment of the drying unit is reduced.

According to the exemplary embodiment of the present invention, the apparatus for manufacturing the ceramic green sheet includes the pollution preventing unit receiving the drying unit to prevent the pollution materials from moving between the drying unit and the outside environment, thereby making it possible to prevent the pollution of the inside or outside environment of the drying unit.

In addition, the present invention can control the pressure in the drying unit without considering the pollution of the environment inside and outside the drying unit, thereby making it possible to manufacture the defect free thin film ceramic green sheet or the completely dried thick film ceramic green sheet while preventing the pollution of the working environment.

Although the exemplary embodiments of the present invention have been disclosed for illustrative purposes, those skilled in the art will appreciate that various modifications, additions and substitutions are possible, without departing from the scope and spirit of the invention as disclosed in the accompanying claims.

Accordingly, the scope of the present invention is not construed as being limited to the described embodiments but is defined by the appended claims as well as equivalents thereto.

What is claimed is:

1. An apparatus for manufacturing a ceramic green sheet, comprising:
an applying unit that applies a slurry to a film;
a drying unit that dries the slurry applied to the film and forms the ceramic green sheet; and
a pollution preventing unit having the drying unit therein to prevent pollution materials from moving between the drying unit and the outside environment.

2. The apparatus for manufacturing a ceramic green sheet according to claim 1, wherein the inside of the pollution preventing unit maintains a negative pressure.

3. The apparatus for manufacturing a ceramic green sheet according to claim 2, wherein when the thickness of the ceramic green sheet is in a thickness range below 0.01 to 2 μm, the inside of the drying unit maintains a positive pressure.

4. The apparatus for manufacturing a ceramic green sheet according to claim 2, wherein when the thickness of the ceramic green sheet is in a thickness range of 2 to 100 μm, the inside of the drying unit maintains a negative pressure.

5. The apparatus for manufacturing a ceramic green sheet according to claim 1, wherein the drying unit includes an exhaust unit and a suction unit disposed along a moving direction of the film.

6. The apparatus for manufacturing a ceramic green sheet according to claim 5, further comprising a filter unit included in the exhaust unit.

7. The apparatus for manufacturing a ceramic green sheet according to claim 1, wherein the drying unit includes an inlet disposed on one side of the drying unit to input the film including the slurry and an outlet disposed on the other side of the drying unit to discharge the film including the green sheet, and
the pollution preventing unit includes an additional inlet disposed before the inlet and an additional outlet disposed after the outlet.

8. The apparatus for manufacturing a ceramic green sheet according to claim 1, wherein the pollution preventing unit includes an additional exhaust unit.

9. The apparatus for manufacturing a ceramic green sheet according to claim 8, further comprising an additional filter unit included in the additional exhaust unit.
